(19) United States
(12) Patent Application Publication
(10) Pub. No.: US 2005/0270277 A1
(43) Pub. Date: Dec. 8, 2005

(54) Portable computer having display mode changed according to attachment/detachment of pen and control method thereof

(75) Inventor: Sang-woo Park, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/140,205

(22) Filed: May 31, 2005

(30) Foreign Application Priority Data
Jun. 3, 2004 (KR) 2004-40509

(51) Int. Cl. G09G 5/00

(52) U.S. Cl. 345/173

(57) ABSTRACT

Disclosed is a portable computer comprising a main body, and a display part having a tablet allowing a user to input information with a pen, and displaying a picture based on a video signal transmitted from the main body. The portable computer has a pen-mounting portion to which the pen is detachably attached; an attachment/detachment sensor detects whether the pen is attached to or detached from the pen-mounting portion; and a controller controlling the display part to have a portrait display mode when the attachment/detachment sensor detects that the pen is detached from the pen-mounting portion, and controlling the display part to have a landscape display mode when the attachment/detachment sensor detects that the pen is attached to the pen-mounting portion.

### CROSS-REFERENCE TO RELATED APPLICATION

This application claims the benefit under 35 U.S.C. §119(a) of Korean Patent Application No. 2004-0040509, filed on Jun. 3, 2004, in the Korean Intellectual Property Office, the entire disclosure of which is incorporated herein by reference.

### BACKGROUND OF THE INVENTION

1. Field of the Invention

The present invention relates to a portable computer and a control method thereof. More particularly, the present invention relates to a portable computer and a control method thereof, in which a display mode is easily changed according to the states in which it is used without a separate button operation.

2. Description of the Related Art

Generally, a portable computer having a tablet function comprises a computer main body provided with a key input part, a touch pad, and the like, allowing a user to input information; and a display part provided with a tablet allowing a user to input information with a pen stylus and displaying a picture thereon, wherein a picture may be a document, handwritten text, graphics or an image.

Here, the tablet is one of the input units used in a computer system, which allows a user to input a letter, an image or the like with the pen to the computer system, thereby improving convenience according to the user's liking. Recently, the usage of portable computer tablets has been on the rise as the environments in which a computer may be used has diversified.

Such a portable computer having the tablet function is changeable between a general personal computer (PC) mode and a tablet mode allowing a user to input the information through the tablet.

In the case of the general PC mode, the display part generally displays a picture in a landscape display mode. In the case of the tablet mode, the display part generally displays a picture in a portrait display mode.

Therefore, the conventional portable computer is separately provided with a button for changing the display mode. For example, when a user wants to make the display part display a picture in the tablet mode, a user selects the button to change the display mode into the tablet mode.

However, it is inconvenient for a user to select the button to change the display mode every time the usage state of the portable computer changes.

### SUMMARY OF THE INVENTION

Accordingly, it is an aspect of the present invention to provide to a portable computer and a control method thereof, in which a display mode is easily changed according to usage states without a separate button operation.

The foregoing and/or other aspects of the present invention are also achieved by providing a portable computer comprising a main body, and a display part having a tablet allowing a user to input information with a pen, and displaying a picture based on a video signal transmitted from the main body, the portable computer comprising a pen-mounting portion to which the pen is detachably attached; an attachment/detachment sensor sensing whether the pen is attached to or detached from the pen-mounting portion; and a controller controlling the display part to have a portrait display mode when the attachment/detachment sensor detects that the pen is detached from the pen-mounting portion, and controlling the display part to have a landscape display mode when the attachment/detachment sensor detects that the pen is attached to the pen-mounting portion.

According to an aspect of the present invention, the controller comprises a microcomputer generating a predetermined key code on the basis of the detected result of the attachment/detachment sensor, and a video driver changing the display mode in correspondence to the key code generated by the microcomputer.

According to an aspect of the present invention, the attachment/detachment sensor comprises a switch for outputting high/low signals according to the attachment and detachment of the pen.

The foregoing and/or other aspects of the present invention are also achieved by providing a method of controlling a portable computer comprising a main body, and a display part having a tablet allowing a user to input information with a pen, and displaying a picture based on a video signal transmitted from the main body, the method comprising sensing attachment/detachment of the pen; and controlling the display part to have a portrait display mode on the basis of the detected detachment of the pen and to have a landscape display mode on the basis of the detected attachment of the pen.

### BRIEF DESCRIPTION OF THE DRAWINGS

The above and/or other aspects and advantages of the embodiments of the present invention will become apparent and more readily appreciated from the following description of the embodiments, taken in conjunction with the accompany drawings of which:

FIG. 1 is a perspective view of a portable computer according to an embodiment of the present invention;

FIG. 2 is a perspective view of the portable computer of FIG. 1 in a tablet mode;

FIG. 3 is a control block diagram of a portable computer according to an embodiment of the present invention;

FIGS. 4A and 4B are views illustrating an example of pictures according to landscape/portrait display modes of an embodiment of the present invention; and

FIG. 5 is a control flowchart of a portable computer according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

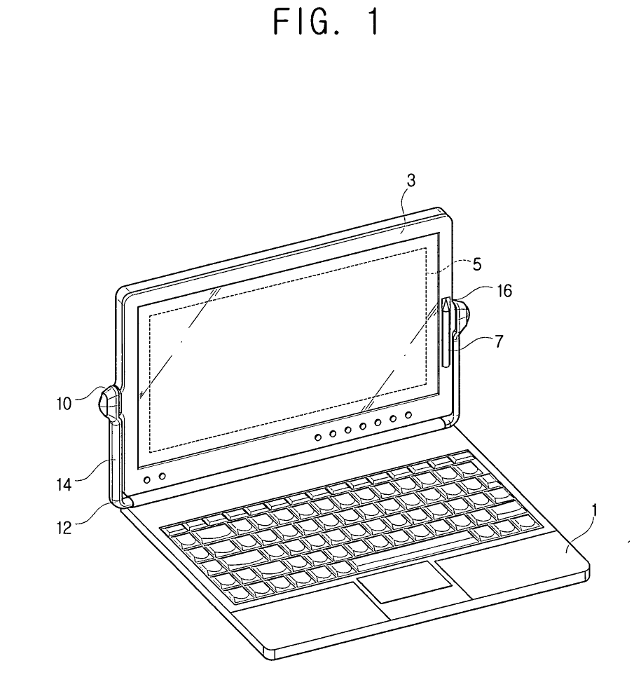

FIG. 1 is a perspective view of a portable computer according to an embodiment of the present invention. As shown therein, a portable computer according to an embodiment of the present invention comprises a main body 1 provided with a key input part allowing a user to input information; and a display part 3 having a tablet 5 allowing a user to input information with a pen 7, rotatably coupled to the main body 1 and displaying a picture based on a video signal received from the main body 1.

Further, the portable computer according to an embodiment of the present invention comprises a first coupling portion 12 placed in a first portion of the display part 3 and rotatably coupled to the main body 1; a second coupling portion 10 placed in a second portion of the display part 3 and rotatably coupled to the display part 3; and a link 14 linking the first coupling portion 12 with the second coupling portion 10.

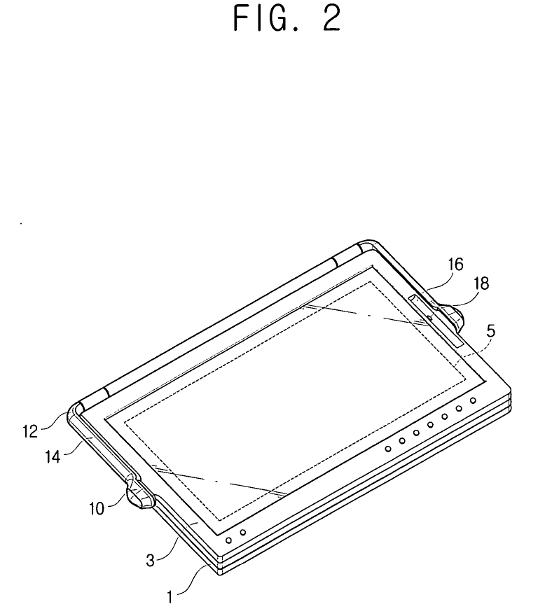

Thus, the portable computer is used as either a general computer in PC mode or a writing surface in tablet mode. In the case of the general PC mode as shown in FIG. 1, the display part 3 is rotated at a predetermined angle to the main body 1, and allows a user to input information through the key input part, a touch pad or the like provided in the main body 1. In the case of the table mode as shown in FIG. 2, the display part 3 is rotated to be in parallel with the main body 1 and to expose a screen of the display part 3 to the outside, and allows a user to input information through the tablet 5 by using the pen or other similar input device. However, the rotatable structure of the display part 3 is not limited to this and may vary.

Referring to FIG. 2, the pen 7, which is used for inputting information, is detachably provided in a pen-mounting portion 16. Here, the pen-mounting portion 16 is provided with a pressure switch 18 to detect whether the pen 7 is attached to or detached from the pen-mounting portion 16.

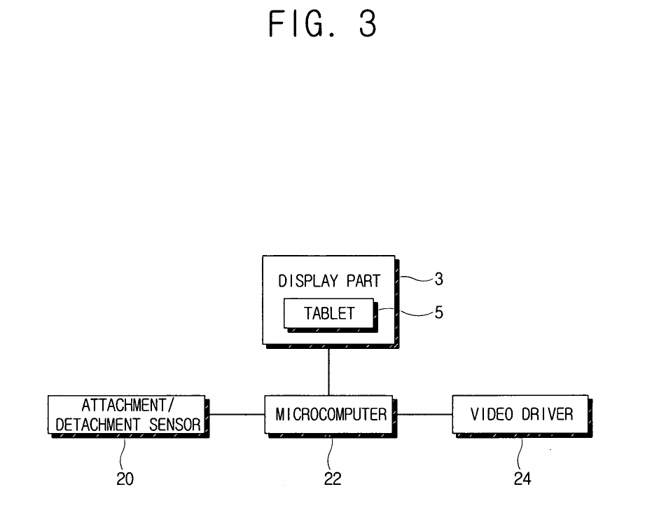

FIG. 3 is a control block diagram of a portable computer according to an embodiment of the present invention. As shown therein, the portable computer according to an embodiment of the present invention comprises a display part 3 provided with a tablet 5 allowing a user to input information and displaying a picture thereon, an attachment/detachment sensor 20 to detect the attachment/detachment of the pen 7, and a microcomputer 22, and a video driver 24.

The attachment/detachment sensor 20 can be realized by the pressure switch 18 (refer to FIG. 2). The pressure switch 18 preferably outputs a low signal to the microcomputer 22 when the pen 7 is attached to the pen-mounting portion 16, and outputs a high signal to the microcomputer 22 when the pen 7 is detached from the pen-mounting portion 16. Alternatively, the pressure switch 18 may output a high signal to the microcomputer 22 when the pen 7 is attached to the pen-mounting portion 16, and output a low signal to the microcomputer 22 when the pen 7 is detached from the pen-mounting portion 16. However, the attachment/detachment sensor 20 is not limited to the pressure switch 18, and may vary as long as the sensor means can output different signals to the microcomputer 22 according to the attachment/detachment of the pen 7.

The microcomputer 22 determines whether the pen 7 is attached to or detached from the pen-mounting portion 16 on the basis of the detection signal (low or high) output from the attachment/detachment sensor 20. Therefore, the microcomputer 22 generates a predetermined key code corresponding to the determination result. The microcomputer 22 controls the video driver 24 to change the display mode of the display part 3 into a landscape display mode when it is determined that the pen 7 is attached to the pen-mounting portion 16, and controls the video driver 24 to change the display mode of the display part 3 into a portrait display mode when it is determined that the pen 7 is detached from the pen-mounting portion 16.

Then, the video driver 24 controls a video card (not shown) to process the video signal depending on the changed display mode, thereby displaying a picture corresponding to the display mode. At this time, the video driver 24 can change the display mode on the basis of the key code generated by the microcomputer 22.

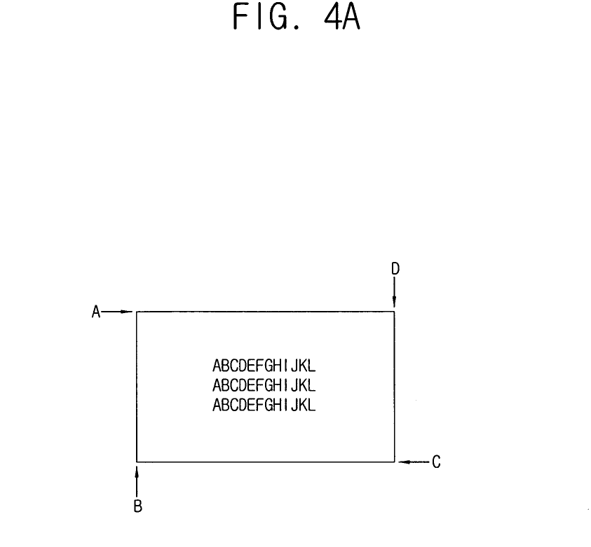

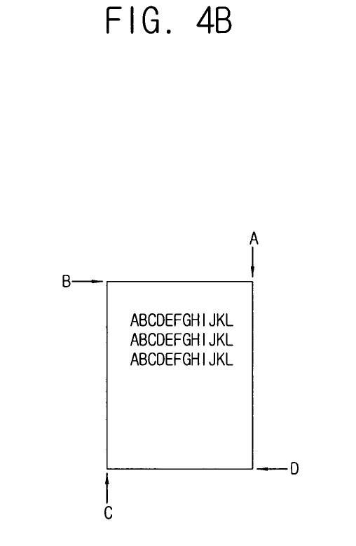

Here, the landscape display mode indicates a case that the horizontal of the display part 3 is larger than the vertical thereof (refer to FIG. 4A), and the portrait display mode indicates a case that the horizontal is smaller than the vertical.

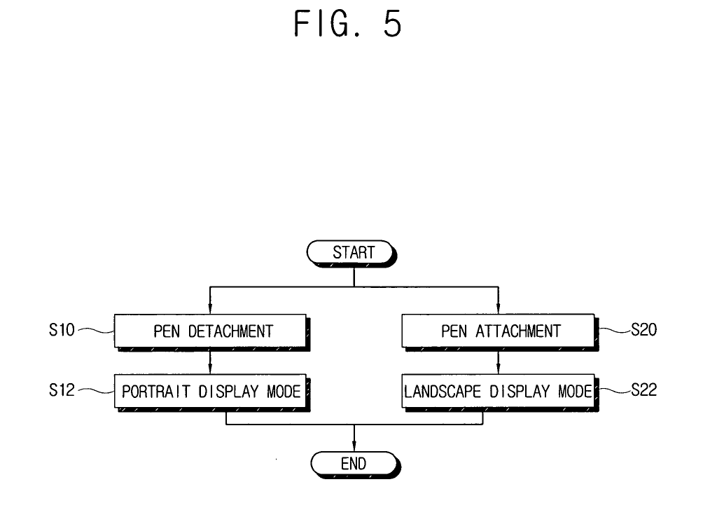

With this configuration, the portable computer according to an embodiment of the present invention is controlled as follows (referring to FIG. 5).

First, the microcomputer 22 determines whether the pen 7 is attached or detached on the basis of the detected signal output from the attachment/detachment sensor 20. At operation S10, it is determined that the pen 7 is detached or attached. The microcomputer 22 controls the video driver 24 to change the display mode into the portrait display mode, when it is determined that the pen is detached (S12). On the other hand, if, at operation S20, it is determined that the pen 7 is attached, the microcomputer 22 controls the video driver 24 to change the display mode into the landscape display mode (S22).

Thus, when the pen is attached to the pen-mounting portion, that is, when the pen is not in use, the display mode of the display part is changed into the landscape display mode, so that the portable computer display is in the proper orientation for the general PC mode. On the other hand, when the pen is detached from the pen-mounting portion, the display mode of the display part is changed into the portrait display mode to facilitate inputting information with the pen, so that the portable computer is automatically changed to have the proper display mode according to the using states of the device.

As described above, embodiments of the present invention provides a portable computer and a control method thereof, in which a display mode is easily changed according to the using states without a separate button operation.

Although, several embodiments of the present invention have been shown and described, it will be appreciated by those skilled in the art that changes may be made in these embodiments without departing from the principles and spirit of the invention, the scope of which is defined in the appended claims and their equivalents.

1. A portable computer comprising a main body, and a display part having a tablet allowing a user to input information with a pen, and displaying a picture based on a video signal transmitted from the main body, the portable computer comprising:
a pen-mounting portion to which the pen is detachably attached;
an attachment/detachment sensor for detecting whether the pen is attached to or detached from the pen-mounting portion; and
a controller for controlling the display part to have a portrait display mode when the attachment/detachment sensor detects that the pen is detached from the pen-mounting portion, and controlling the display part to have a landscape display mode when the attachment/detachment sensor detects that the pen is attached to the pen-mounting portion.

2. The portable computer according to claim 1, wherein the controller comprises a microcomputer generating a predetermined key code on the basis of the detected result of the attachment/detachment sensor, and a video driver changing the display mode in correspondence to the key code generated by the microcomputer.

3. The portable computer according to claim 1, wherein the attachment/detachment sensor comprises a switch for outputting high and low signals according to the attachment or detachment, respectively, of the pen.

4. The portable computer according to claim 1, wherein the attachment/detachment sensor comprises a switch for outputting low and high signals according to the attachment or detachment, respectively, of the pen.

5. The portable computer according to claim 1, wherein the display part further comprises a tablet that accepts inputs from the detached pen when the display is in portrait display mode.

6. A method of controlling a portable computer comprising a main body, and a display part having a tablet allowing a user to input information with a pen, and displaying a picture based on a video signal transmitted from the main body, the method comprising the steps of:
detecting the attachment and detachment of the pen; and
controlling the display part to have a portrait display mode on the basis of detecting the detachment of the pen and to have a landscape display mode on the basis of detecting the attachment of the pen.

7. The method of claim 6, wherein the controlling step further comprises the steps of:
generating a predetermined key code on the basis of the detected result of the attachment/detachment sensor; and
changing the display mode in correspondence to the generated key code.

8. The method of claim 6, wherein the sensing step further comprises outputting high and low signals according to the attachment or detachment, respectively, of the pen.

9. The method of claim 6, wherein the sensing step further comprises outputting low and high signals according to the attachment or detachment, respectively, of the pen.

10. The method of claim 7, further comprising the step of accepting inputs from the detached pen when the display is in portrait display mode.
